(19) United States
(12) Patent Application Publication
(10) Pub. No.: US 2026/0020548 A1
(43) Pub. Date: Jan. 22, 2026

(54) Fish Hook with Spike

(71) Applicant: Berry Mtn., Inc., Liverpool, PA (US)

(72) Inventor: Jarrod Burk Major, Liverpool, PA (US)

(21) Appl. No.: 19/262,519

(22) Filed: Jul. 8, 2025

Related U.S. Application Data
(60) Provisional application No. 63/672,314, filed on Jul. 17, 2024.

(51) Int. Cl. A01K 83/00

(52) U.S. Cl. CPC A01K 83/00

(57) ABSTRACT

A fish hook having a spike that assists in resisting a fish separating from the fish hook once the fish is hooked by the fish hook. The spike can be integrally formed with the fish hook. Alternatively the spike can be part of a separate spike component that is attached to or supported on the fish hook. The fish hook can be a single fish hook, or be a fish hook of a multiple fish hook such as a double hook or a treble hook.

### RELATED APPLICATION

This application is a non-provisional of and claims priority to the filing date of the inventor's U.S. provisional patent application Ser. No. 63/672,314 titled “Fish Hook with Spike” filed Jul. 17, 2024 at attorney docket number 1-3432-P and co-pending when this application was filed.

### FIELD OF THE DISCLOSURE

The disclosure relates generally to fish hooks used for angling.

### BACKGROUND OF THE DISCLOSURE

FIG. 72 illustrates a typical single fish hook F. The fish hook is formed from a single length of wire. The fish hook has one end formed as an eye E. The eye defines an opening that receives and attaches the fish hook to a fishing line, snap, split ring, or the like. A shank S extends longitudinally to a generally U-shaped bend U. The other leg of the bend extends to a sharpened point P at the other end of the fish hook. The point and the shank determine the gap G and the throat T dimensions of the fish hook. The fish hook may include a barb B formed near the point P, or the fish hook may be barbless to minimize physical stress to a released fish.

There are many shapes and sizes of fish hooks, including single fish hooks and multiple hook fish hooks. The fish hooks illustrated in the disclosed embodiments are not intended to limit this disclosure to a specific shape or size of fish hook.

A fish caught on a fish hook may shake the hook out before the fish can be retrieved and successfully landed. The fish hook may be in a soft portion of the fish mouth or palate that can tear and enable the fish hook to slide out or the fish to shake free. A slack line during the retrieve or landing of the fish may also enable the fish to shake free. A fish jumping or rolling may also enable the fish hook to separate from the fish.

It is therefore desirable to provide a fish hook that can resist the fish separating from the fish hook once the fish is hooked by the fish hook.

### SUMMARY OF THE DISCLOSURE

Disclosed is a fish hook that includes an auxiliary or additional spike or projecting member that assists in resisting a fish separating from the fish hook once the fish is hooked by the fish hook.

A single fish hook can be provided with the disclosed spike. In other possible embodiments a multi-fish hook assembly such as a double hook or treble hook can be provided with one or more spikes.

In some single fish hook embodiments, the spike extends from or near the eye towards the gap. In other single fish hook embodiments the spike extends from near a portion of the shank towards the gap.

In some single fish hook embodiments the single fish hook and spike are formed from the same length of wire. The fish hook and spike form a unitary, homogeneous, one piece member.

In yet other single fish hook embodiments the spike is formed as a separate component that is attached or fastened to the fish hook. The spike may be fixedly attached to the fish hook or may be attached to allow some play or relative movement between the spike and the fish hook.

In multiple fish hook embodiments, a single spike may be provided or multiple spikes may be provided. A respective spike may be provided for each fish hook of the multiple fish hooks.

The fish hook in further embodiments may have components extending from a fishing lure body (for example, a jig head). The fish hook for example may have an eye portion extending from the lure body and a shank portion extending from the lure body. The fish hook may be continuous from the eye portion to the shank portion, or the lure body may connect the eye portion to a separate, spaced apart shank portion.

Other objects and features of the disclosure will become apparent as the description proceeds, especially when taken in conjunction with the accompanying drawing sheets of illustrative, non-limiting embodiments.

### BRIEF DESCRIPTION OF THE DRAWINGS

FIGS. 1 and 2 are front and side views respectively of a fish hook with a spike in accordance with this disclosure.

FIG. 3 is a side view of a fish hook with a spike in accordance with this disclosure.

FIG. 4 is a side view of a fish hook with a spike in accordance with this disclosure.

FIG. 5 is a side view of a fish hook with a spike in accordance with this disclosure.

FIGS. 6 and 7 are side and front views of a portion of a fish hook that is configured to receive and support a spike in accordance with this disclosure.

FIGS. 8 and 9 are the same views as FIGS. 6 and 7 respectively but illustrate a spike component carried by the fish hook.

FIGS. 10 and 11 are the same views as FIGS. 8 and 9 respectively but includes a split ring 60 attached to the eye of the fish hook.

FIGS. 12 and 13 illustrate the spike component shown in FIGS. 10 and 11 in first and second relative positions respectively with respect to the fish hook.

FIG. 14 illustrates a split ring cooperating with a spike support of a fish hook to attach the spike component in a substantially fixed position relative to the fish hook.

FIGS. 15 and 16 illustrate a fish hook having an eye being configure to resist the spike component from sliding past the eye of the fish hook.

FIG. 17 illustrates a fish hook having an that is also configured to retain a spike component on the fish hook without use of a split ring.

FIGS. 18 and 19 illustrate a fish hook having an oblong eye and a spike component collar placed over the eye.

FIG. 20 is similar to FIG. 3 but the fish hook includes an offset shank portion.

FIG. 21 shows a spike component mounted on a fish hook, a spike formed from the lower coil of the spike collar.

FIGS. 22 and 23 each illustrate a fish hook and spike component assembly, the spike component assemblies having different spike configurations.

FIGS. 24, 25, and 26 are front, left side, and right side views respectively of a fish hook and spike component assembly having a split ring disposed in the fish hook eye and the spike collar received within the split ring.

FIG. 27 illustrates a fish hook and spike component being retained in the fish hook eye by upper and lower split rings.

FIGS. 28 and 29 illustrates a fish hook with a split ring having an outer diameter larger than the fish hook eye diameter that resists displacement of a spike collar out of the eye.

FIGS. 30, 31, and 32 is a partial sectional view, a side view, and a front view respectively of a fish hook and a split ring extending outwardly beyond the eye of the fish hook to resist a spike component from slipping off the eye.

FIG. 33 illustrate a double fish hook and a spike component located at a waist of the double fish hook.

FIG. 34 illustrates a double fish hook having a spike component and a split ring attached to the fish hook.

FIG. 35 is similar to FIG. 34 but illustrates an alternative means for mounting a spike collar to the eye of the fish hook.

FIGS. 36-41 illustrate different examples of treble hooks having spikes.

FIGS. 42-59 illustrate a jig head and different hooks and spike collars being attached to the jig head.

FIG. 60 is similar to FIG. 12 but includes a pair of spikes extending from a spike collar.

FIGS. 61-65 illustrate a fish hook similar to the fish hook shown in FIG. 6 but with a spike support formed by deforming a leg of the fish hook eye to form a support surface.

FIG. 66 illustrates the fish hook shown in FIG. 61 with a spike component supported on the support surface.

FIGS. 67-70 FIGS. 61-65 illustrate a fish hook similar to the fish hook shown in FIG. 6 but with a spike support formed by an arcuate length of wire forming a support surface.

FIG. 71 illustrates the fish hook shown in FIG. 67 with a spike component supported on the support surface.

FIG. 72 is a side view of a prior art fish hook.

### DETAILED DESCRIPTION

FIGS. 1-5 illustrate embodiments of a single fish hook having a spike, the fish hook and spike formed from a single length of wire.

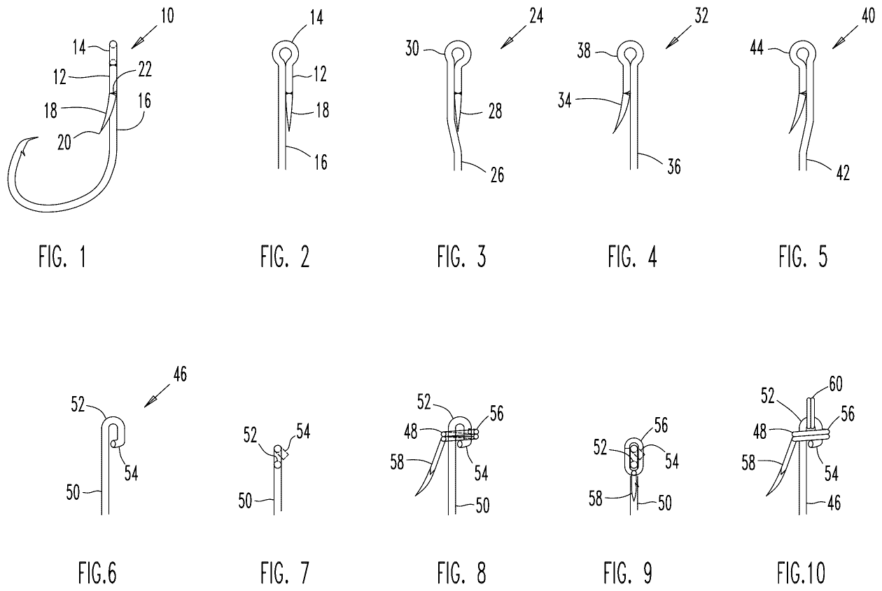

FIGS. 1 and 2 are front and side views respectively of a single barbed fish hook 10 in accordance with this disclosure. The fish hook includes a spike 12. The fish hook and the spike are formed from a single piece of wire. The spike is formed as an extension of the eye 14. The spike extends from the eye along the shank 16. The spike includes a free end portion 18 that curves laterally away from the shank and away from the plane of the eye. The spike free end portion ends at a sharpened point 20 and includes a barb 22 in addition to the fish hook barb. The eye is centered over the shank and spike portions at the eye.

FIG. 3 is a view similar to FIG. 2 of a single fish hook 24 similar to the fish hook 10. The fish hook 24 is also formed from a single wire. The shank includes an offset straight shank portion 26 that is beyond the end of the spike 28. The eye 30 is configured to be substantially centered over the offset shank portion.

FIG. 4 is a view similar to FIG. 3 and illustrates a single fish hook 32 similar to the fish hook 10. The fish hook 32 is also formed from a single wire. In this embodiment the spike 34 curves away from a non-offset shank 36 but remains co-planar with the eye 38. The eye is centered over the offset shank portion.

FIG. 5 is a view similar to FIG. 4 and illustrates a single fish hook 40 similar to the fish hook 32. The fish hook has an offset straight shank portion 42. The eye 44 is centered over the offset shank portion.

FIGS. 6 and 7 illustrate a single fish hook 46 that is configured to receive and support a spike that is formed as part of a separate member or spike component 48 (see FIG. 8) from the fish hook.

The single-wire fish hook 46 includes a shank 50 that extends to an oblong, U-shaped eye 52. A spike support 54 extends from the end of the eye spaced away from the shank. The spike support extends perpendicularly with respect to the eye and extends away from the eye a relatively short distance as shown in FIG. 6.

FIG. 7 is a top view of the fish hook 46 looking down on the spike support 54. The spike support extends outwardly from the eye at an acute angle with respect to the shank center line.

FIGS. 8 and 9 illustrate the spike component 48 mounted against the fish hook spike support 54. The spike component is made from a single length of wire. The spike component has a spike collar 56 and an integral spike 58. The spike collar is formed as a two-layer helical wire ring that defines an oblong through opening extending along a longitudinal opening axis. The opening is sized to closely receive the eye 52. The opening closely receives the eye and enables the spike collar to be supported against the spike support. The spike collar resists rotation of the spike component about the eye. The spike extends away from the spike collar from one end of the wire forming the wire ring. The spike component is configured to have the spike extend from the collar in a direction away from the shank 50 and in the plane of the eye.

FIG. 9 is the same view of the fish hook 46 shown in FIG. 8. The spike collar 56 is wound with a generally rectangular outer perimeter to receive the eye 52. The spike collar forms a non-rotatable connection with the eye.

FIGS. 10 and 11 illustrates the fish hook 46 and the spike component 48 as shown in FIG. 8 but includes a split ring 60 threaded onto the eye 52. The spike collar 56 is sandwiched and disposed between the split ring and the fish hook spike support 54. The outside diameter of the split ring is sized to resist sliding of the spike collar past the split ring and off of the eye. Split rings are widely available in different sizes and materials, making them convenient for use in retaining or otherwise attaching a spike component to a fish hook.

FIG. 11 is the same top view of the fish hook 46 as shown in FIG. 9. The split ring 60 seen extending beyond the opposite sides of the spike collar 56 to resist movement of the spike member 48 past the split ring.

Clearance can be provided between the spike collar 56 and the split ring 60 that enables some relative displacement of the spike component 48 and the fish hook 46.

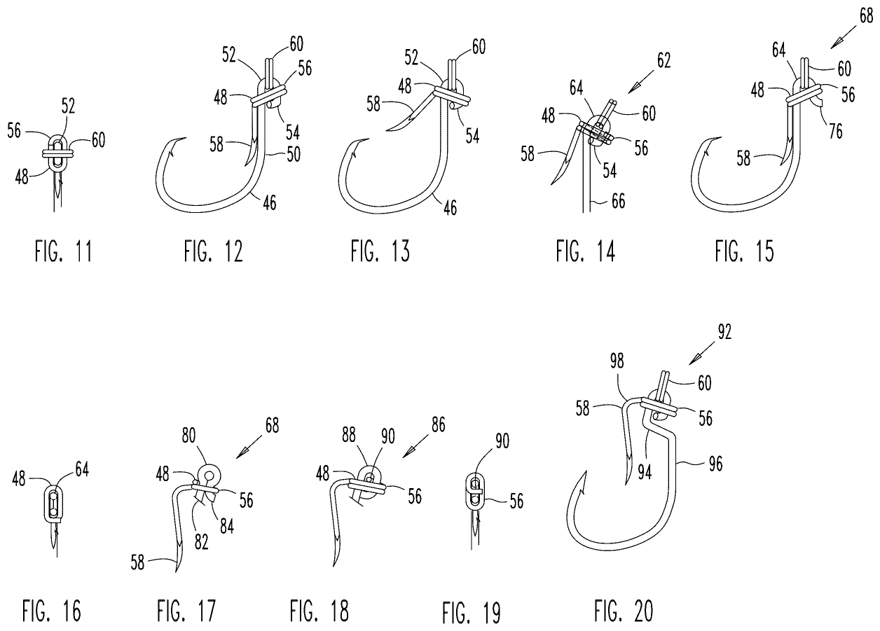

FIG. 12 illustrates the spike component 48 in a first relative position with respect to the eye 52 of the fish hook 46. The spike 58 extends along the shank 50. A first side of the split ring 60 engages against the spike component. Vertical clearance in the direction of the shank 50 enables the spike component to pivot about the outer surface of the spike support 52 to a second relative position shown in FIG. 13. An opposite second side of the split ring 60 now engages against the spike component. The spike component has pivoted about the outer surface of the spike support 52 in a clockwise direction from the first relative position as viewed in FIG. 12. In this second relative position the spike is extending towards the point of the fish hook. The spike in effect now reduces the throat of the fish hook and further resists a fish slipping off the fish hook.

FIG. 14 illustrates the split ring 60 cooperating with the spike support 54 of a single fish hook to attach the spike component 48 in a substantially fixed position relative to the fish hook.

A fish hook 62 has an eye 64 that initially bends away from the shank 66, rotating the eye as compared to the eye shown in FIG. 6. The spike component 48 is attached over the eye. The spit ring 60 is sized to effectively hold the spike collar 56 stationary against the spike support 54. The spike collar opening axis is inclined with respect to the shank. The spike 58 initially extends from the spike collar in a direction parallel with the spike collar opening axis.

FIGS. 15 and 16 illustrate a fish hook 68 having an eye 70. The eye has a “U”-shaped portion 72 having one leg extending from the shank 74. The second leg of the eye portion 72 has an arcuate eye segment 76 that extends from the end of the second leg away from the shank. The spike collar 56 is placed over the eye. The arcuate eye segment extends beyond the inner diameter of the spike collar and prevents the spike component 48 from sliding along the shank past the eye. The split ring 60 is sized to resist sliding of the spike collar past the split ring and off the eye.

FIG. 16 is a top view of the fish hook 68 that shows the relative position of the spike component 48 disposed about the eye 70.

FIG. 17 illustrates a fish hook 78 having a generally circular eye 80. Rather than stopping against the shank 82, the eye also includes a reverse arcuate eye segment 84 extending away from the shank. The spike component collar 56 is threaded or formed around the narrowed waist of the eye to position and retain the spike component 48 on the fish hook without use of a split ring. The spike 58 extends away from the spike collar in a first direction before bending downwardly.

FIGS. 18 and 19 illustrate a fish hook 86 having an oblong eye 88. The spike component collar 56 is threaded or placed over the eye. The wire end 90 of the spike collar opposite the spike end extends on one side of the spike collar along a diameter (in the sense of extending between directly opposite sides of the spike collar opening) of the spike collar opening to extend into the eye. The wire end retains the spike component 48 on the eye. FIG. 19 illustrates the wire end 90 extending across the opening of the spike collar 56.

FIG. 20 shows a fish hook and spike component assembly 92 similar to that shown in FIG. 13. FIG. 20 illustrates the fish hook shank 94 can include an offset shank portion 96. The spike 58 can extend away from the spike collar 56 with an offset 98 away from the shank before extending towards the fish hook gap. The figure illustrates that a shank offset and spike offset from the shank can be used to position the spike relative to the fish hook gap or point of the fish hook.

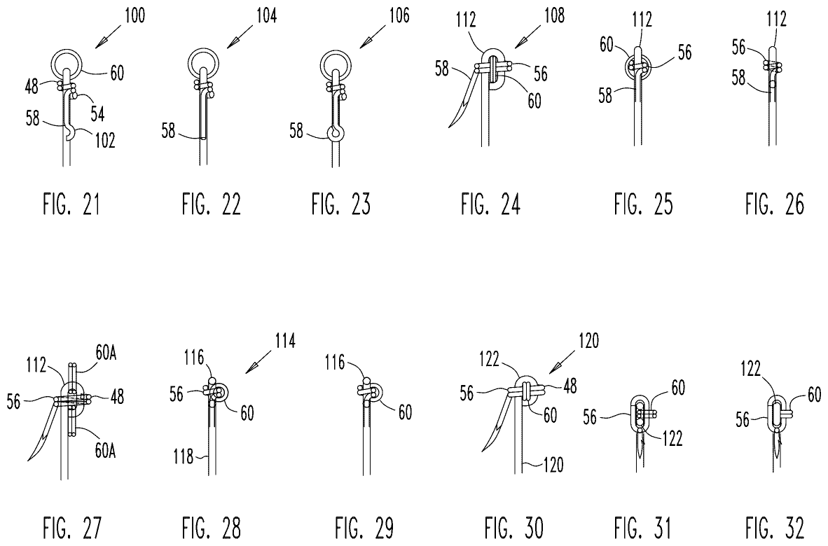

FIG. 21 shows a fish hook 100 similar to the fish hook 46 shown in FIG. 6 in having a spike support 54. The spike component 48 is against the spike support. A split ring 60 threaded onto the ring prevents the spike component from sliding past the split ring. The lower coil of the spike collar rests against the spike support. The wire forming the lower coil extends along the shank to form the spike 58. The spike in this embodiment is not a pointed or barbed spike. The spike has an arcuate free end 102 that resists entering the fish.

FIGS. 22 and 23 illustrate a fish hook and spike component assembly 104, 106 respectively. The assemblies are similar to the assembly shown in FIG. 21 but with different spike embodiments. In FIG. 22 the spike 58 is formed as a straight portion of wire extending along the shank. In FIG. 23 the spike 58 has a closed eye end.

FIGS. 24-26 illustrate a fish hook and spike component assembly 108. FIG. 24 is a front view of the assembly. FIG. 25 is a left side view of the assembly. FIG. 26 is a right side view but the split ring is removed from the view.

The fish hook 110 has an oblong eye 112. A split ring 60 is disposed inside the eye with the split ring opening extending along an axis perpendicular to the shank axis. The spike collar 56 extends around the eye but is received within the split ring. The split ring and the spike collar cooperate to retain the spike collar attached to the fish hook eye.

FIG. 27 illustrates a fish hook similar to the fish hook 108 shown in FIG. 24. The eye 112 is received in the spike collar 56 of the spike component 48 as shown in FIG. 19. In this embodiment the spike component is retained on the eye by an upper split ring 60A and a lower split ring 60B threaded on the eye. The spike collar is sandwiched and disposed between the split rings. The split rings are sized to resist the spike collar from sliding past them and off the eye.

FIGS. 28 and 29 illustrate a fish hook 114 having a round eye 116. The spike collar 56 of the spike component 48 is disposed in the eye with the spike collar opening extending parallel with the shank 118. A split ring 60 extends around one side of the spike collar. The split ring opening extends along an axis perpendicular to the spike collar opening axis. The split ring extends out from the adjacent side of the eye. The split ring has an outer diameter larger than the eye diameter and resists displacement of the spike collar out of the eye.

FIG. 30 is a partial sectional side view, FIG. 31 is a side view, and FIG. 32 is a front view illustrating a fish hook 120 in which an oblong eye 122 is received in the spike collar 56 of a spike component 48. The spike collar opening axis is aligned parallel with the shank 124 where the shank extends away from the eye. A split ring 60 is threaded onto one side of the spike collar with the axis of the split ring opening perpendicular to the shank. The split ring extends outwardly from the one side of the split ring and extends outwardly beyond the eye. The split ring resists the spike component 48 from slipping off of the eye.

FIG. 33 illustrates a double fish hook 210. The double fish hook is made from a single wire. The double fish hook includes a fish hook 212 and a fish hook 214 joined together by a single circular eye 216 forming a reduced width waist where the wire forming the fish hooks bend in towards each other at the base of the eye. The spike component 48 is located at the waist with the spike collar 56 extending around the waist as shown in the figure. The opposite end portions of the wire forming the spike collar form respective spikes 58A, 58B. The spike collar can have a non-round or rectangular opening that can form a non-rotatable connection between the spike component and the eye. The spike component is located about the waist wherein each spike is aligned with and extend towards the throat of a respective fish hook.

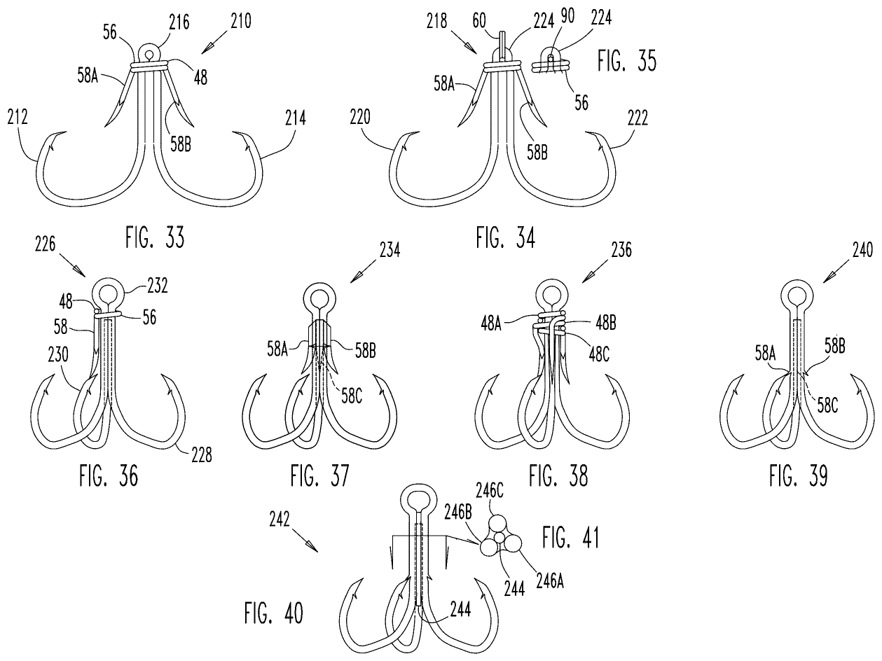

FIG. 34 illustrates a double fish hook 218 made from a single wire. The double fish hook includes a fish hook 220 and a fish hook 222 joined together by a relatively narrow “U” shaped eye 224 forming a reduced width waist where the wire forming the fish hooks bend in towards each other at the base of the eye. The spike component 48 receives the eye through the opening of the spike collar 56 and extends about the waist. The opposite end portions of the wire forming the spike collar form respective spikes 58A, 58B. The spike collar can have a non-round or rectangular opening that can form a non-rotatable connection between the spike component and the eye. A split ring 60 threaded on the eye resists movement of the spike collar past the split ring. The spike component is placed on the eye wherein each spike is aligned with and extend towards the throat of a respective fish hook.

FIG. 35 illustrates an alternative method of mounting the spike collar 56 to the eye 22 using a cross member 90 similar to the cross member 90 shown in FIG. 18.

FIGS. 36-41 illustrate use of spikes with treble hooks.

FIG. 36 illustrates a treble hook 226 formed as a double fish hook 228 and a single fish hook 230 fixed to the double hook. The wire forming the double hook forms the eye 232 that has a circular portion that extends outwardly from where the fish hooks join the eye. The single fish hook is spaced away from the eye. The spike component 48 has a spike collar 56 that encircles the double fish hook just below the eye. The third fish hook and the eye retain the spike component on the treble hook. The spike collar forms a non-rotatable connection between the spike component and the fish hook that maintains the spike hook 58 extending along the shank of one of the fish hooks.

FIG. 37 illustrates a treble hook 234. Fixedly attached to the the shanks of the fish hooks forming the treble hook are spikes 58A, 58B, and 58C that extend along the respective shanks they are attached to.

FIG. 38 illustrates a treble hook 236 similar to the treble hook 226 shown in FIG. 41. The treble hook 236 has an eye 238 sufficiently spaced away from the single fish hook to enable three spike components 48A, 48B, 48C to encircle the fish hook below the eye. The spike components form non-rotatable connections with the treble hook that align the spike components with respective fish hooks of the treble hook. The spike components 48 may have different spike lengths to compensate for their stacked positions along the treble hook.

FIG. 39 illustrates a treble hook 240 similar to the treble hook 226 shown in FIG. 40. The hooks of the treble hook include spikes 58A, 58B, and 58C formed on respective ones of the fish hook shanks. The spikes 58 are formed as barbs that each extend towards the throat of the respective fish hook. The illustrated spikes 58 are disposed on the shanks of the fish hooks at or near the bend of the fish hook. Spikes can also be formed as barbs in the bends of the fish hooks and, in embodiments, formed on the opposite side or leg of the bend from the side or leg having the fish hook point. The treble hook 240 has a spike on each fish hook, but other embodiments of a multi-hook fish hook have spikes on less than all the fish hooks or can have multiple barb spikes on one or more of the fish hooks.

FIGS. 40 and 41 illustrates a treble hook 242 with spikes configured like the spikes of the treble hook 240 shown in FIG. 43. In this embodiment the treble hook has a support 244 disposed between the shanks 246A, 246B, 246C of the fish hooks. The support in the illustrated embodiment is a length of wire that extends along the shanks of the fish hooks and terminates near the eye.

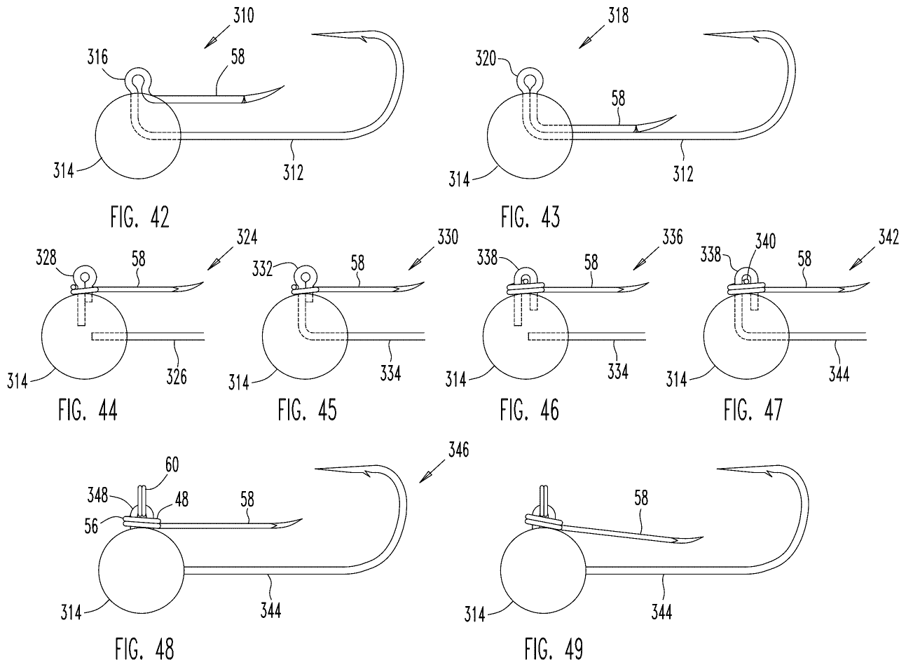

FIGS. 42-59 illustrate use of a spike with a fishing lure body. The illustrated lure body is a jig head made of lead or steel.

FIG. 42 illustrates a single fish hook 310 with an integral spike 58 formed with a single length of wire. The fish hook has a shank 312 that extends into a jig head 314. The fish hook wire bends upwardly as viewed in the figure to form an eye 316 extending from an upper side of the jig head. The fish hook wire continues from the eye to form the spike 58. The spike is spaced above the shank and extends parallel with the shank to a pointed end that curves away from the shank.

The gap between the spike and the shank enables a natural bait, a soft-plastic trailer bait such as a worm, tube bait, or skirt, or the like to be attached to the jig head with the spike 58 extending along the outside of the bait.

FIG. 43 illustrates a single fish hook 318 with an integral spike 58 attached to the jig head 314. In this embodiment the spike 58 extends from the eye 320 and emerges from the jig head closely adjacent to the fish hook shank 322.

FIG. 44 illustrates a fish hook 324 that includes a shank portion 326 that extends into the jig head 314 and a separate eye portion 328 attached to and extending away from the jig head. A spike component 48 has a spike collar 54 attaching the spike component to the eye portion outside of the jig body. A spike 58 extends away from the spike collar and gapped above the shank.

FIG. 45 illustrates a single fish hook 330 formed from a single length of wire attached to a jig head 314. The fish hook has a hook eye 332. A spike component 48 identical to the spike component shown in FIG. 44 mounts the spike 58 to the eye with a gap between the hook shank 334 and the spike 58.

FIG. 46 illustrates a jig head and accompanying fish hook-spike component assembly 336 similar to that shown in FIG. 44. The eye 338 is a “U” shaped eye. A spike component 48 attaches the spike 58 to the eye. The spike collar 56 of the spike component extends around the eye and includes a cross wire 340 that extends into the eye and retains the spike collar in a similar manner as discussed with respect to the spike component shown in FIG. 18.

FIG. 47 illustrates a jig head 314 and accompanying fish hook-spike component assembly 342 that is similar to that shown in FIG. 46. The fish hook 344 is formed as a single wire fish hook.

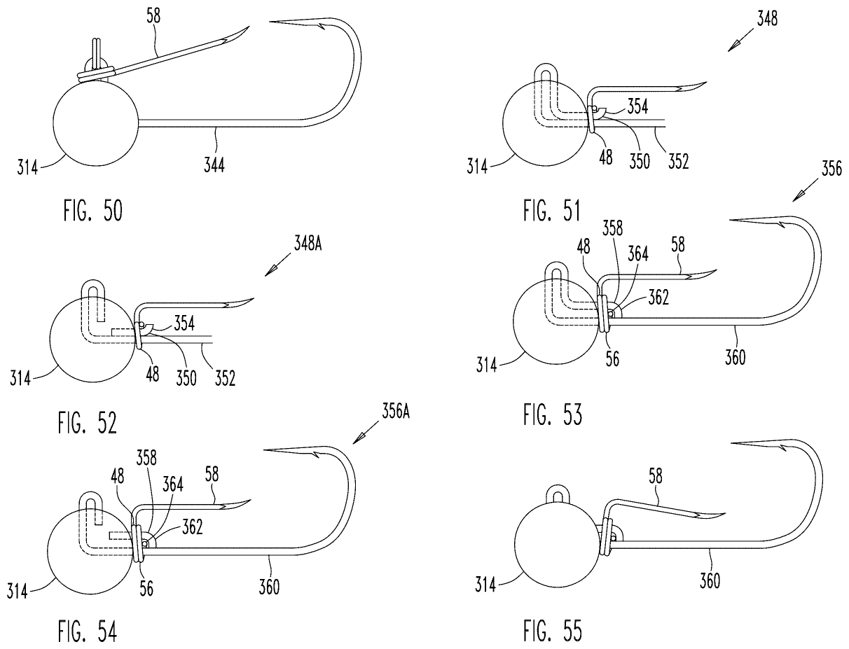

FIG. 48 illustrates a spike component 48 attached to an eye 346 extending from the jig body 314. The eye is received in the opening of the spike collar 56 of the spike component. A split ring 60 that extends about the eye sandwiches and locates the spike collar between the split ring and the jig body to resist movement of the spike collar past the jig head or the split ring. Clearance between the split ring and the spike collar enables relative pivoting of the spike 58 relative to the eye as shown in FIGS. 53 and 54. The spike defines a relatively smaller gap between the spike and the shank as shown in FIG. 49 or a relatively larger gap between the spike and the shank as shown in FIG. 50.

FIGS. 51-57 illustrate the spike component 48 attached to other than the eye of the fish hook.

FIGS. 51 and 52 illustrate a single fish hook 348, 348A respectively having a wire end portion 350 extending out from the jig head 314 above the shank 352. The wire end portion extends a short distance along the shank and terminates in an arcuate hook portion 354 extending away from the shank. The spike component 48 surrounds the shank and wire end portion. The spike collar 56 is sandwiched and disposed between the jig head and the arcuate hook portion. The spike 58 extends away from the jig head. The jig head and the arcuate hook portion cooperate and resist displacement of the spike collar along the shank and fix the spike collar relative to the shank.

FIG. 51 illustrates the fish hook 348 can be formed as a one-piece member. FIG. 52 illustrates the fish hook 348A can be formed with a separate wire end portion fixedly connected to the eye by the jig head 314. The spike 58 can be offset away from the spike collar 56 to form a gap between the spike and the shank for the spike to overlay a natural or man-made bait attached to the jig head.

FIGS. 53 and 54 illustrate a jig head 314 and accompanying fish hook-spike component assembly having a single fish hook 356, 356A respectively. Each fish hook has a wire end portion 358 extending out from the jig head 314 above the shank 360. The wire end portion is spaced from the shank and extends a short distance along the shank. The wire end portion terminates in an arcuate wire portion 362 extending to the shank. The spike collar 56 of the spike component 48 surrounds the shank and wire end portion. The wire end portion and the shank define a slot that is configured to enable a cross wire 364 of the spike collar 56 to be received into the slot and extend across the width of the arcuate wire portion. The cross wire and the spike collar are disposed adjacent to the arcuate wire portion and the jig head respectively and act to limit or minimize displacement of the spike component 48 relative to the jig head and the fish hook.

FIG. 53 illustrates the fish hook 356 can be formed from a continuous length of wire. FIG. 54 illustrates the wire end portion 356 can be formed as a separate wire member fixed to the remainder of the fish hook 356A by the jig head 314.

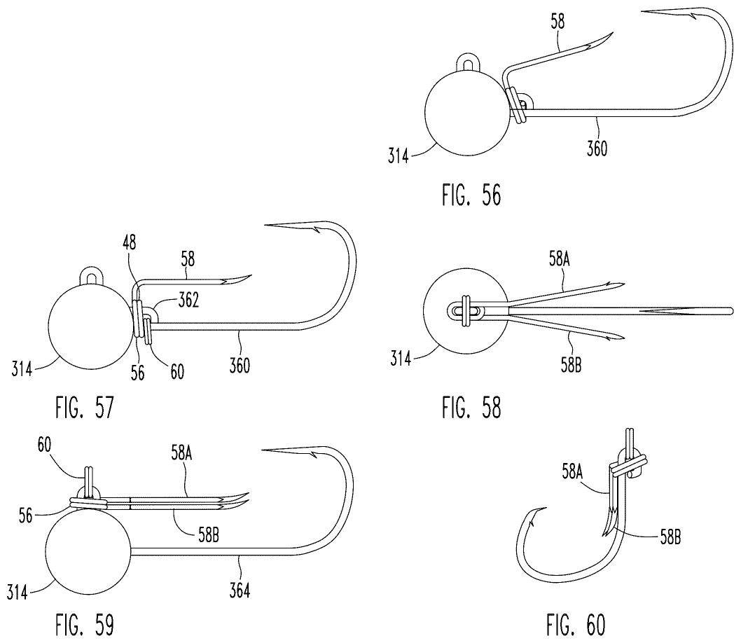

FIGS. 55 and 56 illustrate the assembly shown in FIG. 53 or FIG. 54 made with clearances between the spike collar 56, the jig head 314, and the fish hook 356 that enables some displacement of the spike component 48 relative to the jig head and the fish hook. FIG. 55 illustrates the spike 58 in a relatively lowered position relative to the shank 360. FIG. 56 illustrates the spike 58 in a relatively raised position relative to the shank 360.

FIG. 57 illustrates an assembly similar to that shown in FIG. 53 or 54 in which the spike collar 56 is formed without the cross member. A split ring 60 is threaded about a portion of the shank 360 facing the slot. The split ring can abut the arcuate wire portion 362 at the end of the slot. The spike collar is closely sandwiched and disposed between the jig head 314 and the split ring. The jig head and split ring resist displacement of the spike component 48 relative to the jig head 314 or the fish hook 356.

FIGS. 58 and 59 are top and side views of an assembly similar to that shown in FIG. 48. The only difference is that the spike component 48 has two spikes 58A, 58B extending from opposite ends of the wire forming the spike collar 56. The spikes 58 extend away from each other as they extend away from the jig head 314. The gap between the fish hook shank 364 and the spikes 58 enable a bait to be received between the shank and the spikes as previously described. Because there are two spikes, the spikes can better and more broadly support a bait received into the gap.

FIG. 60 illustrates an assembly similar to the assembly shown in FIG. 12 but with the a pair of spikes 58A, 58B extending away from the spike collar 56. The spikes can extend away from one another similar to the spikes shown in FIG. 58.

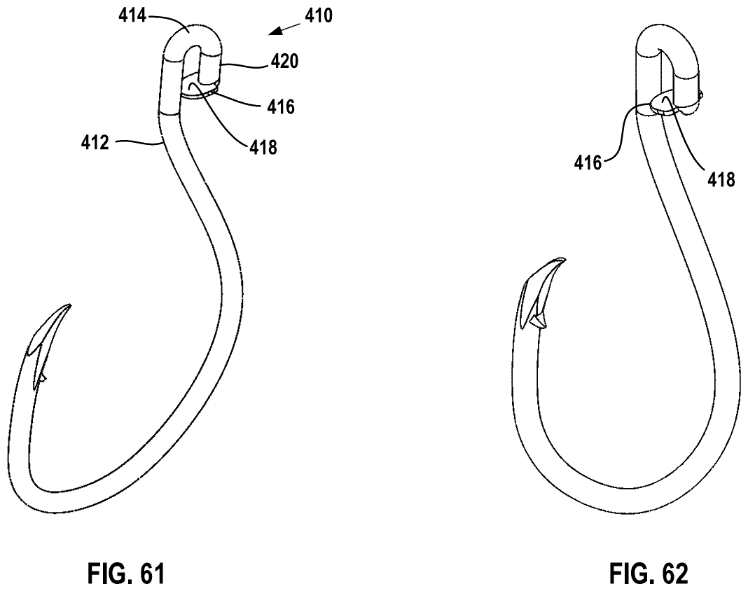

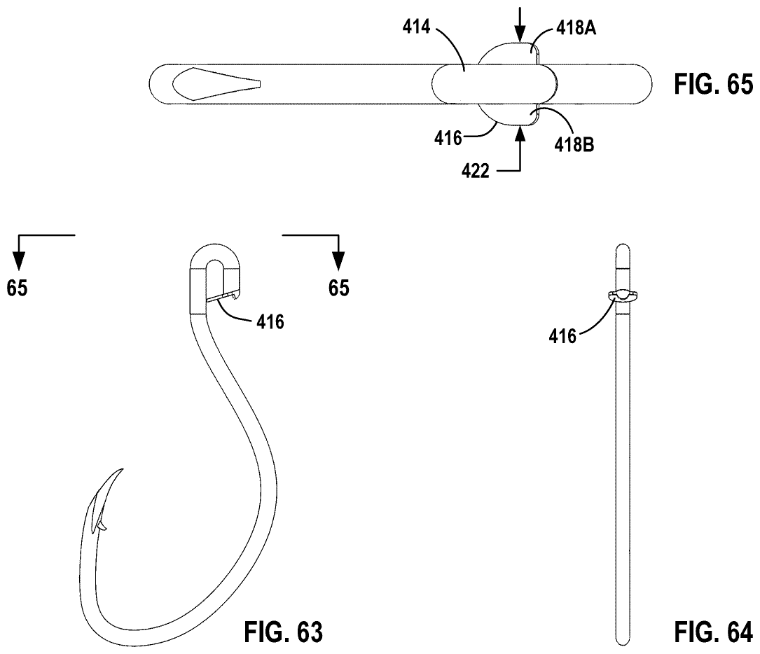

FIGS. 61-65 illustrate a fish hook 410 similar to the fish hook 46 shown in FIG. 6. The fish hook 410 is also configured to receive and support a spike that is formed as part of a separate member or spike component 48 (see FIG. 8).

Like with the fish hook 46, the shank 412 of the fish hook 410 extends to an oblong, U-shaped eye 414. Instead of a spike support 54, a portion of the free end of the eye is “coined” (stamped or otherwise deformed), to form a generally circular cylindrical body 416 that lies in a relative horizontal plane perpendicular to the adjacent leg of the eye. The cylindrical body defines a flat upper support surface 418. The cylindrical body and its support surface extend radially outwardly from the adjacent leg 420 of the eye 414 and extend into the gap between the legs of the eye. The cylindrical body has a diameter dimension 422 substantially greater than the hook wire diameter so that the support surface has a pair of support surface portions 418A, 418B disposed on opposite sides of the eye. To save material, the thickness of the cylindrical body is preferably as thin as possible sufficient to provide adequate strength and rigidity to support and fish with the spike.

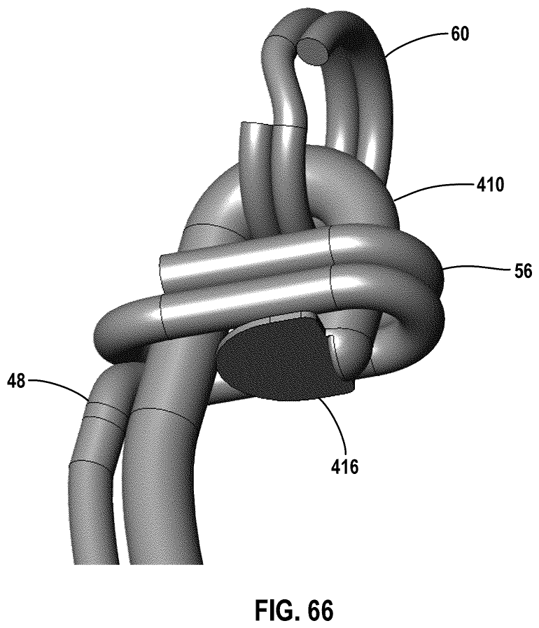

FIG. 66 illustrates the spike component 48 mounted on the fish hook 410. The spike component 48 is against the top surface 418 of the support body 416. A split ring 60 locates the spike collar 56 between the split ring and the support body 416. The spike collar is supported against both support surfaces 418A, 418B (see FIG. 65).

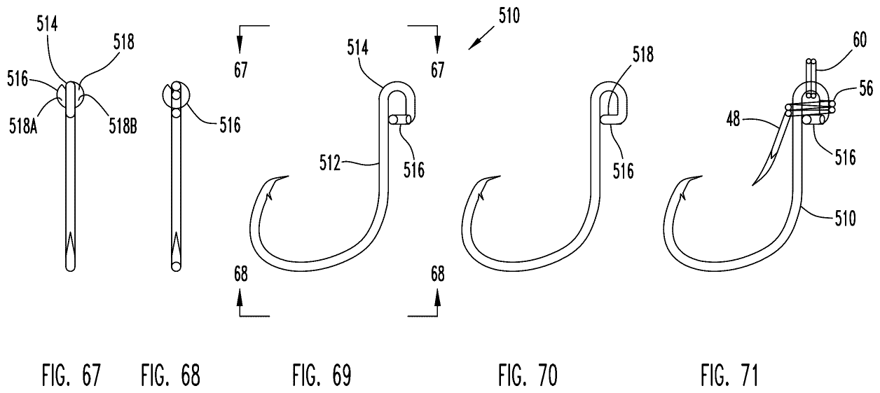

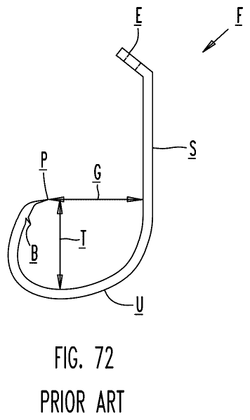

FIGS. 67-70 illustrate a fish hook 510 similar to the fish hook 46 shown in FIG. 6 that is configured to receive and support a spike that is formed as part of a separate member or spike component 48 (see FIG. 8).

Like with the fish hook 46, the shank 512 of the fish hook 510 extends to an oblong, U-shaped eye 514. Instead of a spike support 54, a portion of the free end of the eye formed as an arcuate length of wire that curves and extends along a substantial portion of a circle. The wire forms a body 516 that substantially fills a circular cylindrical volume or disk between the adjacent leg of the hook eye 514 and the shank. The body 516 is disposed in a plane that is perpendicular to the adjacent leg of the eye whereby the body 516 defines an upper support surface 518. The body 516 extends radially outwardly from the eye 514 and defines pair of support surface portions 518A, 518B disposed on opposite sides of the eye.

FIG. 71 illustrates the spike component 48 mounted against the fish hook horizontal eye and with a split ring 60 that locates the spike collar 56 between the split ring and the horizontal eye. The spike collar is supported against both support surfaces 518A, 518B.

Each of the support surfaces 418, 518 locate the spike component 48 along the eye of the fish hook and resists movement of the spike component 48 past the support surface.

While this disclosure includes one or more illustrative embodiments described in detail, it is understood that the one or more embodiments are each capable of modification and that the scope of this disclosure is not limited to the precise details set forth herein but include such modifications that would be obvious to a person of ordinary skill in the relevant art including (but not limited to) changes in material selection, fish hook size and configuration, environment of use, lure body construction (including the size and shape of jig heads or other lure bodies) and the like, as well as such changes and alterations that fall within the purview of the disclosure and claims.

What is claimed is:

1. A fish hook and spike in combination comprising:
a fish hook and a spike with the fish hook;
the fish hook comprising a bend, a shank, and a sharpened point, the bend comprising a pair of legs, the shank extending from one leg, the sharpened point formed on an end of the other leg;
the spike attached to the fish hook, at least a portion of the spike extending along a longitudinal axis to a free end of the spike, the sharpened point of the spike on the free end of the spike, the point of the spike being spaced away from the point of the fish hook.

2. The fish hook and spike of claim 1 wherein the fish hook and the spike are formed from a continuous length of wire to form a one-piece unitary member formed solely from the wire.

3. The fish hook and spike of claim 1 wherein the fish hook defines a gap between the point of the fish hook and the shank, and the spike extends along the spike axis towards the gap.

4. The fish hook and spike of claim 3 wherein the fish hook comprises the shank extending from the bend to an eye of the fish hook, the spike extending from at or adjacent the eye towards the gap.

5. The fish hook and spike of claim 3 wherein the spike extends from the shank towards the gap.

6. The fish hook and spike of claim 1 wherein the spike is a separate member from the fish hook.

7. The fish hook and spike of claim 1 comprising a spike component that is a separate member from the fish hook;
the fish hook comprising an eye;
the spike component comprising a spike collar and the spike extending away from the spike collar, the spike collar defining an opening that receives the eye.

8. The fish hook and spike of claim 7 comprising a split ring disposed about the eye, the split ring being configured to resist movement of the spike collar past the split ring.

9. The fish hook and spike of claim 7 wherein the spike collar comprises a longitudinal member that extends into and out of the eye wherein the longitudinal member resists movement of the spike collar in a direction wherein the longitudinal abuts against the eye.

10. The fish hook and spike of claim 7 wherein the spike collar encloses a narrowed portion of the eye.

11. The fish hook and spike of claim 7 wherein the spike component is fixedly attached to the fish hook.

12. The fish hook and spike of claim 7 wherein the spike component is attached to the fish hook with a limited amount of play relative to the fish hook that allows for limited displacement of the spike relative to the fish hook.

13. The fish hook and spike of claim 7 wherein the fish hook is formed from a continuous length of wire extending from a first and portion of the wire;
the eye being adjacent the first end portion of the wire;
the first end portion of the wire comprises a surface that engages the spike collar and resists movement of the spike collar past the second end portion when the spike collar receives the eye.

14. The fish hook and spike of claim 13 wherein the first end portion is a round body, the surface being a flat surface of the round body that extends outwardly beyond opposite sides of the eye.

15. The fish hook and spike of claim 13 wherein the first end portion is a portion of the fish hook wire that extends along an arcuate path, the surface being a surface of the portion of the fish hook wire that extends outwardly beyond opposite sides of the eye.

16. The fish hook and spike of class 1 wherein the fish hook is a first fish hook of a double fish hook that includes the first fish hook and a second fish hook, and a second spike attached to the second fish hook.

17. The fish hook and spike of claim 1 wherein the fish hook is a first fish hook of a treble fish hook that includes the first fish hook, a second fish hook, and a third fish hook, and comprising a second spike attached to the second fish hook.

18. The fish hook and spike of claim 17 comprising a third spike attached to the third fish hook.

19. The fish hook and spike of claim 1 comprising a lure body, the eye of the fish hook and the shank of the fish hook extending outwardly from the lure body, the spike and shank extending out of the lure body.

20. The fish hook of claim 19 wherein the spike extends from the lure body parallel with and immediately adjacent to the shank.

21. The fish hook of claim 19 wherein the spike and shank define a second gap therebetween.

22. The fish hook and spike of claim 1 comprising a lure body, the eye of the fish hook and the shank of the fish hook extending outwardly from the lure body, the shank extending out of the lure body, the spike attached to the eye and extending away from the eye towards the gap.

23. The fish hook and spike of claim 22 wherein the spike extends in a length dimension and the spike is spaced away from the shank along the entire length dimension.
